(19) United States
(12) Patent Application Publication
(10) Pub. No.: US 2006/0036537 A1
(43) Pub. Date: Feb. 16, 2006

(54) RISK MANAGEMENT IN AN EXPEDITIOUS FUNDS-HOLDER PAYOR AUTHENTICATION AND FUNDS TRANSFER SYSTEM AND METHODOLOGY

(75) Inventors: Steve LAWRENCE, Nassau (BS); Gord HERMAN, Isle of Man (GB)

Correspondence Address: SEAN W. GOODWIN, 237- 8TH AVE. S.E., SUITE 360, THE BURNS BUILDING, CALGARY, AB, T2G 5C3, CA

(73) Assignee: NETELLER PLC, Calgary (CA)

(21) Appl. No.: 10/906,531

(22) Filed: Feb. 23, 2005

Related U.S. Application Data
(63) Continuation-in-part of application No. 10/926,968, filed on Aug. 27, 2004.
(60) Provisional application No. 60/600,366, filed on Aug. 11, 2004.

(51) Int. Cl. G06Q 40/00

(52) U.S. Cl. 705/39

(57) ABSTRACT

A method and system for enables expeditious transfer of funds electronically to an end merchant substantially instantaneously upon the request of a new payor or client. An intermediary service having a server in communication with an automated clearinghouse system and having a client interface provides an online account for transfer of at least a permitted portion of requested funds to the merchant account of a participating end merchant at the request of a payor client. The intermediary verifies the client's identify through a series of authenticating questions including those verifying non-financial information for establishing the client's authorization to access the client's source account for settlement of the transferred funds. In another embodiment, a merchant indemnification system provides further financial security for the end merchant.

### CROSS REFERENCE TO RELATED APPLICATION

This application claims priority of U.S. Provisional Patent application Ser. No. 60/600,366 filed Aug. 11, 2004 and US Regular Patent application 10/926,968 filed Aug. 27, 2004 both to Lawrence et al., the entirety of which are incorporated herein by reference.

### FIELD OF THE INVENTION

The invention relates to a method for authenticating a user-member's identity and transferring funds to a specified destination account in advance of the usual verification of the successful withdrawal and settlement from the user-member's financial account during an automated clearinghouse cycle.

### BACKGROUND OF THE INVENTION

Hundreds of thousands of electronic fund transfers (EFT) representing millions of dollars are processed daily through the use of credit cards, debit cards and transfers. Point of sale (POS) or face-to-face transactions include various safeguards to minimize fraud and abuse of these transactions including presentation of the actual physical instrument or card, signature verification and presentation of supplementary identification.

Financial transactions are also occurring through distributed network or online systems such as the internet. These online transactions have few or none of the assurances or ease of right-to-use verification of the POS situations. Further, some online services and merchants often use merchant accounts or intermediate financial accounts into which customers deposit funds. While withdrawals are readily permitted from most financial instruments, such as in the case of payment for services, fewer are able to enable deposits from that instrument into a destination account.

Online merchants traditionally only conduct basic verifications of the payment means such as to confirm the client's zip or postal code or whether the card has been reported stolen. Online verification is readily thwarted if a credit card is stolen along with the card owner's personal information or identity.

Accordingly, in this higher risk environment, third party intermediaries are now providing online accounts and online verification services for verifying the purported owner's right of access to a payment means and enabling EFT to the merchant. Also, in many instances, the client may themselves desire to use an intermediary between themselves and the vendor so as to shield sensitive financial and personal information from the recipient, often in what is an isolated transaction with a vendor of unknown repute. Typically, a client makes a payment to the intermediary, who then funds an online, intermediary account. While withdrawals are readily permitted from most financial instruments such as credit cards, fewer online systems are able to enable payments to an intermediary account. Therefore, it is usual in an online scenario to perform an EFT from a client's account.

There are still risks to the merchant. First, the merchant is accepting a third party's verification of the fund transfer. Ultimately, if there is a chargeback to the third party intermediary's online account for a customer (such as a disputed authorization), then typically, the value of the chargeback is deducted from the funds settlement forwarded periodically to the merchants.

The risk is further intensified in situations where the desire for substantially instantaneous access to funds is desired. Typically, an EFT requires upwards of 4 days to clear an applicable automated clearinghouse (ACH-System). ACH-System qualifying receiving account and client account information is provided. The settlement date for payment is delayed so that the account details and sufficient funds in the client's account can be confirmed. Thus, in some time-sensitive financial transactions, the client may be precluded or prejudiced from participating in a financial opportunity due to the time lag between making an offer and the ACH-System settlement process. Further, systems using credit history to assess the authenticity of a client necessarily reduce the population of capable clients to those in the restricted categories of property owners and the like.

Accordingly, there is a need for an arrangement and method for expeditious authentication and funds transfer.

### SUMMARY OF THE INVENTION

A payment service is provided for enabling expeditious payment of funds from an intermediate, online payor's account for use in making payment to a merchant or other account, such as in satisfaction of a financial transaction. A payment service is a financial intermediary which manages a plurality of online payor or client accounts. If the client's identity is verified, a permitted amount of funds in the online account is allocated to the client and which can be made available for immediate withdrawal transfer to the credit of a merchant's account without need to wait for ACH-System to clear the funds from the client's source account. Settlement is then made between the client's source account at a financial institution and the like to the financial intermediary. The risk of a returned item to the financial intermediary is reduced through a novel identity verification system.

In this system for instantaneous account funding, there are several steps. The payor goes through an identity verification and the payor identifies the financial source from which the intermediary will settle the online account. In the sign up, the payor signs up as a client and provides sufficient information so that that queries can be made regarding the client's background. Additionally, at the sign up step or later step, the client database registers a bank account with the financial intermediary. This involves entering information about the account (such as an account number, routing/transit number) that the payor would prefer as the source account from which to pay funds. The payor advises the financial intermediary of the particulars of their source account including the financial information or coordinates such as that encoded on a check associated with a client's chequing account.

In order to authorize and initiate a payment to an end merchant and pledge payment from the source account, the payor is required to pass an online identity verification process. Once the payor passes the identity verification, the financial intermediary substantially immediately funds the client's online payor account. This verification process varies by geographical region, but typically consists of answering 2-4 questions about the payor. Contrary to the usual case of merely confirming financial data against a credit bureau, the population of qualifying payors is substantially increased through an emphasis on non-financial information. In contradistinction to credit bureau formats, these questions are general in nature rather than financial. General questions are typically non-financial questions. If the payor answers the questions correctly, the payor is qualified to have a permitted modest amount (e.g. $750) immediately credited to their online payor account for immediate transfer to the end merchant. Where available, during identify verification, the existence about the client's source account is also confirmed through ATM Verify. Preferably, the amount deposited is initially limited and reduces the risk to the financial intermediary by setting a maximum loss amount in the event the client's source account fails an ACH-System withdrawal transaction.

The financial intermediary then initiates the more time-consuming ACH-System process for recovering the permitted amount from the source account. Although the funds are available for transfer immediately, the corresponding settlement withdrawal from the source account to the intermediary account can take up to 4 days to clear the client's source account.

In such cases, the financial intermediary obtains a fee, typically as a fixed amount or percentage of the amount transferred. In one embodiment, as the funds being requested for payment to the online account are for a specific amount to meet a specific merchant payment, the financial intermediary withdraws the settlement amount which includes the transferred amount and their fee.

Alternatively the client may choose, or upon failing to meet a verification threshold, the client can be required to enter a delayed (several days) account verification process. The financial intermediary can perform one or more transactions at the source account which can be reviewed and confirmed by the client. For instance a small test deposit can be confirmed by the client by making payment of an identical value to the online account. Test deposits arrive in American client's accounts in 1-2 working days and 1-5 working days in Canadian client's accounts. Once the amount has been confirmed, the source account and online account are then available for use.

Therefore, in a broad aspect of the invention, a method is provided for making an expeditious transfer of funds to an end merchant at the request of a client without waiting for settlement of an electronic fund transfer from a source account of the requesting client. The method comprises: providing an intermediary service having a server system in electronic communication with at least the client, the client's source account, the end merchant, and an intermediate account; receiving at the intermediary service a request from the requesting client to transfer an amount of requested funds to the end merchant from the client's source account; obtaining from the requesting client an assertion of the requesting client's authorization to transfer funds from the source account; authenticating the client's authorization to transfer funds from the source account by establishing a strength of the assertion and at least a permitted amount of the requested funds to be transferred based on the strength of the client's assertion; substantially contemporaneous with the authentication, initiating a first electronic fund transfer of the least a permitted amount of the requested funds from the intermediate account as transferred funds which are transferred to the end merchant; and thereafter initiating a settlement transaction including submitting a second electronic fund transfer for seeking to recover at least the permitted amount of the requested funds from the source account to the intermediary account.

Typically, the assertion includes posing two or more authenticating questions to the client, one of which is non-financial, and preferably all of which are non-financial. Further, preferably the existence of the client's source account is confirmed through a verification of the existence and accessibility or legitimacy of the source account through the ACH-System.

The intermediary services can further reduce the risk to the end merchant in an indemnification process wherein the intermediary service facilitates an irrevocable advance of funds to an end merchant by a requesting client without waiting for a successful settlement of an electronic fund transfer from the requesting client. The indemnification method comprises: providing an intermediary service having a server system in electronic communication with the client, the end merchant, and an intermediate account; receiving at the intermediary service a request from the requesting client to transfer an amount of requested funds to the end merchant from a source account; irrevocably committing at least a permitted amount of the requested amount of the requested funds by initiating a first electronic fund transfer from the intermediate account as transferred funds which are transferred to the end merchant; and thereafter initiating a settlement transaction including submitting a second electronic fund transfer for seeking to recover at least the permitted amount of the requested funds from the source account to the intermediary account.

### BRIEF DESCRIPTION OF THE DRAWINGS

FIG. 1 is a block diagram illustrating one embodiment of a system and methodology for an irrevocable advance or transfer of funds from a client to an end merchant;

FIGS. 2a-2d are a continuum of block diagrams illustrating an embodiment of conventional and expedited transfer of funds to an end merchant from an intermediate online account as initiated by a client; and

FIG. 3 is a block diagram illustrating another embodiment of a system and methodology for indemnification of the end merchant.

### DETAILED DESCRIPTION OF A PREFERRED EMBODIMENT

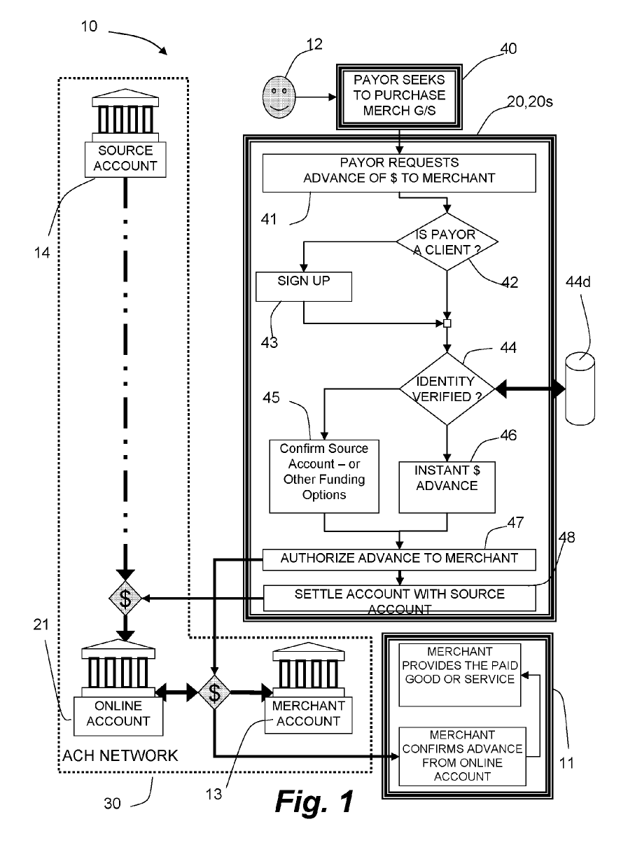

With reference to FIG. 1, a consumer wishes to spend money; now. One embodiment of a methodology and system 10 is illustrated for enabling expeditious authorization and payment of funds pledged by the consumer payor or client 12 for a payment to a merchant or other account such as in satisfaction of a financial transaction.

An online merchant seeks to receive money; now. The online merchant seeks funds from the client 12 for a good or a service including a disbursement made by the merchant on behalf of the client. The online merchant is the end recipient of the funds transferred thereto for satisfaction of the client's financial obligations and thus, such a merchant is termed herein an “end merchant 11”. For example, the client 12 may be a customer of the end merchant 11 and funds are needed to initiate or participate in the merchant's goods or services. An example is an end merchant 11 who themselves commit a monetary amount to another merchant or some irredeemable transaction. To minimize their risk, the end merchant 11 will obtain payment into a merchant account 13 or often require the client 12 to hold a positive balance in this merchant account 13 prior to commencing the activity. Typically, the client would fund the account from a source account 14.

Conventional EFT Takes time (Prior Art)

Prior art or conventional mechanisms to fund the merchant account 13 can be slow and are subject to charge-backs. Such mechanisms include electronic fund transfer EFT, including online cheques, and credit cards. Herein, funding advanced from a client through financial institutions and credit means such as credit cards are all deemed to be from source accounts 14 of the client 12. In the conventional systems, to satisfy the end merchant's financial demand, the client 12 requests a transfer of funds, and, an EFT and a deposit is acknowledged at the recipient end merchant account's 13. Settlement of an EFT takes some time before the transaction clears the source account 14. In either case, the end result is that settlement from the client's source account 14 could fail (be dishonoured) and no funds would ultimately be withdrawn or, even if withdrawn, initiation of a charge-back could reverse any such withdrawal or debit made from that source account 14. Thus, whether the source account 14 has insufficient funds, there was fraudulent transaction or a fraudulent initiation of a charge-back, the recipient or end merchant 11 would normally have to surrender the transferred funds. For the protection of consumers from fraudulent transactions, and under agreements between financial institutions and between credit card issuers and merchants, charge-backs are to be honored by the recipient, typically the end merchant 11, to the benefit of the consumer client.

Therefore, in high risk transactions, it is the usual case to await settlement before an end merchant 11 themselves commit the funds. As set forth in the present embodiment, end merchants 111 prefer to avoid being the recipient and subsequent relinquisher of the ill-fated funds in the aforementioned scenario.

Expedited Advancement of Funds

Simply then, and with reference again to FIG. 1, when a consumer payor desires to advance funds to an end merchant 111 or the end merchant seeks funds from the payor, the payor signs up as a client 12 of an intermediary service 20 who then makes a first transfer to credit funds to the end merchant's account 13 from an online account 21 of the intermediary service 20. As the end merchant is a participant in the system, the intermediary service 20 is known to end merchant 11, and a pledge of funds from the online account 21 is accepted without delay by the end merchant 11. Effectively, the client 12 can spend now and the end merchant received the funds now.

At block 35, when a payor seeks to expeditiously advance funds to an end merchant 11 for the purchase of goods or services, the payor contacts the intermediary service 20. The intermediary service 20 receives the request at block 41 and confirms at block 42 if the payor is already a client 12 of the intermediary service 20, and if not, signs up the payor as a client 12 at block 43. The intermediary service 20 assesses if the client 12 meets certain criteria. At block 44, if the identity of the client 12 is verified, then the client 12 qualifies at block 46 for an expeditious or instant first transfer of a specified amount of the funds to the end merchant 11; if not, the client 12 is required to confirm their source account through other means or provide other funding options at block 45. For an instant advance, the intermediary service 20 allocates at least a portion of the funds in the intermediate online account 21 to the credit of the client 12. It is understood that the online account 21 can be discrete accounts for each client 12 or more likely to be a combined account having a pool of funds of the intermediary service 20, portions of which are allocated to a plurality of clients 12,12 . . . at any particular time and maintained in client ledgers. Funding of the client's online account 21 typically entails a ledger entry to allocating a value to a client 12 in the online account 21.

The intermediary service 20 and the end merchant 11 are known to each other, funds in the online account 21 are deemed to represent sufficient financial security for the end merchant 11 to conduct the service or provide the goods as originally sought.

At block 47, the intermediary service 20 transfers the funds, advanced to the client 12, from the online account 21 to the end merchant's account 13. At block 48, the intermediary service 20 initiates and subsequently settles its own online account 21 through a second transfer as a conventional EFT from the client's source account 14. The end merchant 11 typically manages a plurality of transferred and received funds to the credit of a plurality of destination client account ledgers of the end merchant's merchant account 13 or accounts. The client 12 can make periodic access to a whole or a part of the transferred funds in the merchant account 13 expressly for purchasing the goods or services of the end merchant 11.

The intermediary service 20 is integrated with financial services for transferring funds. The intermediary service 20 therefore comprises one server 20s, or one or more servers 20s, (fancifully represented in FIG. 1 as synonymous with the intermediary service 20) in electronic communication over a distributed network such as the internet. The server 20s is in electronic communication with an automated clearinghouse system (ACH-System 30) which is authorized to engage and settle electronic financial transactions. The intermediary service 20 further comprises the online account 21 which is in communication with the ACH-System 30.

In the US, the Federal Reserve Banks are collectively the largest automated clearinghouse operators in the ACH-System 30. There are also private-sector ACH-System operators processing the balance of the financial transactions. More information is available at the National Automated Clearinghouse Association (NACHA) at www.nacha.org. In Canada, an equivalent ACH-System is the Automated Clearing Settlement System (ACSS) handing about 99% of the volume of transactions and the Large Value Transfer System (LVTS) which clears about 85% of the value of the transfers such as in settlements of a day's cumulative transactions. More information is available from the Canadian Payments Association at www.cdnpay.ca.

The server 20s is also in communication with the participating end merchant 11 which has the merchant account 13 in communication with the ACH-System 30. A participating end merchant 11 is one who has entered into a contract with the intermediary service 20 so as to receive funds under an embodiment of the invention.

The server 20s is in communication with clients 12 of the end merchant 11. Clients 12 represent or assert to the intermediary service 20 that they have a source account 14 from which they will fund financial transactions. The client 12 provides transit, institution and account numbers representing the identification of the source account 14. Such a source account 12 is in communication with the ACH-System 30.

The server 20s has an interface for interacting with the client 12 for receiving a request to make an EFT, for receiving details of a source account 14 and for engaging the client 12 in at least one level of verification of the client's right to access the source account 14. The server 20s manages clients 12 and client information for conducting the requested transfer of funds and any subsequent transactions.

Risk Management

The system 10 is one of allocating and managing risk. The provision of an intermediary service 20 and online account 21 is particularly useful to assist both an end merchant 11 and the client 12. The end merchant 11 seeks to offer the client 12 access to the services immediately rather than risk losing the interest of the client 12. Also, the client 12 seeks to use the services of the end merchant 11 now and would prefer not to wait, for fear of losing an opportunity. As discussed, the problem with such a financial transaction is that, on one hand, the end merchant 11 is reluctant to release transferred funds in advance of settlement of an EFT and thus delays gratification of both parties. On the other hand, the client 12 may not have immediate access to funds or the transaction is the first of which with this particular end merchant 11 and there is no prior positive balance in the end merchant's account 13 or prior financial history to speak of.

In such a scenario, where funds are to be transferred and applied expeditiously, there is a greater risk to the end merchant 11 where the transferred funds can be or are committed elsewhere before settlement. If the settlement fails then the end merchant 11 loses. Thus, in another embodiment discuss below, indemnification of an end merchant 11 by the intermediary service 20 becomes an attractive and additional option, as the turnaround between a request and transfer of the funds becomes more expeditious.

The intermediary service 20 exists in part to assess and absorb the risks to the end merchant 11 and offers the client 12 and end merchant 11 expeditious access to funds. The intermediary service 20 enables expeditious payment of funds to the online account 21 for use in making payment to the end merchant 11. The intermediary service 20 is a financial intermediary which manages funds for a plurality of clients 12. As described above, at a client's request and upon the proper validation of the client's rights to funds in the source account 14, funds are substantially contemporaneously and irrevocably transferred from the intermediary services online account 21 to the merchant's account 13 and thus made available for immediate withdrawal by the end merchant 111 or client 12 without need to wait for the ACH-System 30 to clear the funds from the client source account 14. Subsequently, the client's source account 14 at a financial institution is debited to the credit of the intermediary service 20 and the online account 21. A client ledger is maintained on behalf of the client 12 to distinguish funds in the online account 21.

As discussed at block 44, the risk of a returned item to the financial intermediary service 20 is reduced through a novel identity verification system. In one embodiment of this system for the expeditious, substantially instantaneous funding of the merchant account 13, there are several steps: signing up with the intermediary service 20 as a client 12, verification of the client's identity and identification of the client's source account 14.

Briefly, in a signup step, the payor confirms they are known to the intermediary service 20 as a client 12 or they are signed up as a client 12. As a client 12, basic identification is provided. In the verification step, in order to pledge an advance from a client's source account 14 to the online account 21 for transfer to the end merchant 11, the client 12 is required to pass an online identity verification process and thereby provide an assertion that they are authorized to transfer funds from that source account 14. The intermediary service 20 performs the identify verification as a risk assessment of the client's ability to pay. Even if successful, the intermediary service typically and initially limits the maximum amount of funds which can be advanced to the end merchant 11. Due to the risks to the intermediary service 20 of a dishonoured EFT or charge-back, the intermediary service 20 typically charges a fee which, on a cumulative basis for a plurality of transactions, is statistically sufficient to exceed losses. Such a fee can be obtained as part of the settlement with the source account 14.

Sign Up

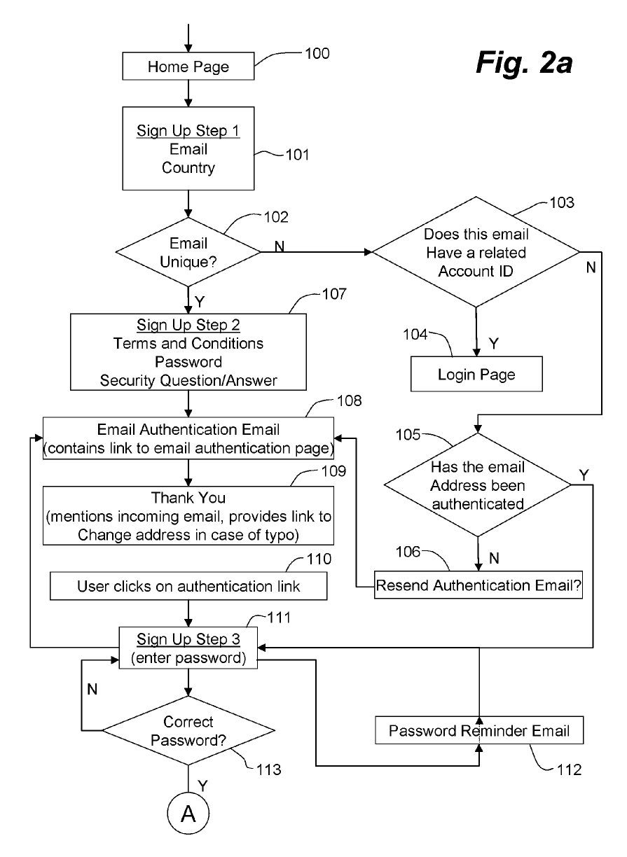

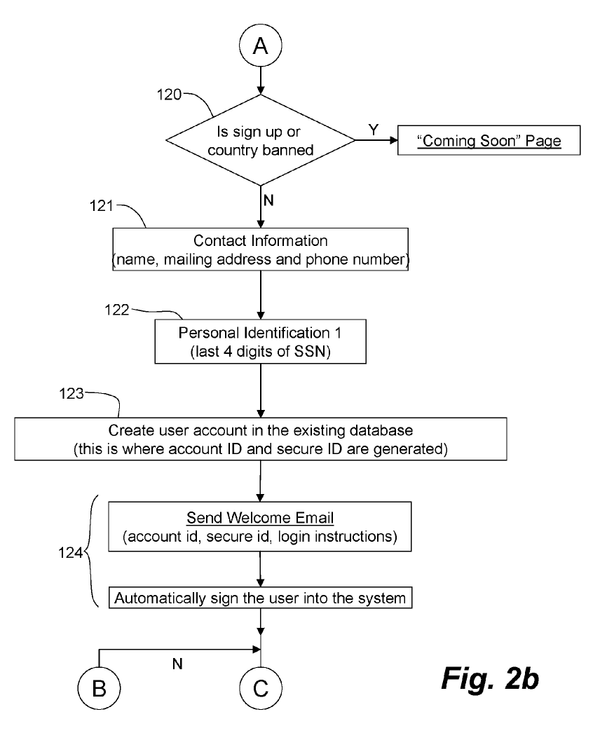

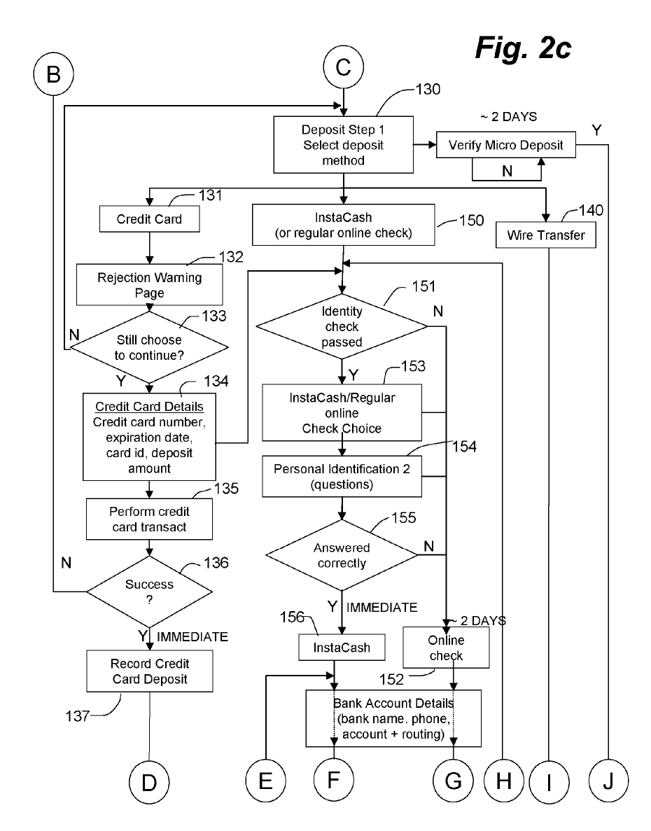

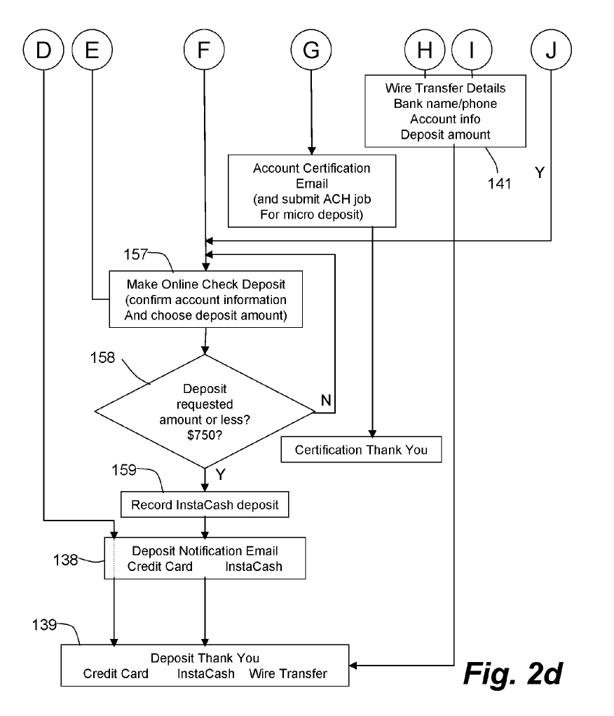

In greater detail then and turning to FIG. 2a, a prospective client 12 is signed up and a more or less conventional routine is established for confirming email communication and choosing a unique login name and a password. More particularly, an internet browser interface is contemplated having a home page at block 100. At block 101, in the sign up with the intermediary service 20, the client 12 becomes a member of the service 20 through providing an email address, at block 102, and if the email address exists, evidencing a returning member, at block 103, returning client 12 is then asked to login, at block 104. Note that a variety of sign up routines are possible for establishing an online account with a service. Only one such embodiment is disclosed herein.

If the email has not been authenticated, at block 105 then, at block 106, an authenticating email is forwarded to the client 12 for confirming their sign up and receipt of same at block 110. If the email is unique and thus a new member, then the client 12 is directed to sign up, at block 107, for review of terms and conditions of the intermediary service and assigning of a login password or other security means, including forwarding of an authentication email through the provided email address at block 108. Notification of the incoming email is provided at block 109. Once authenticated at block 105, the client 12 is invited at block 111 to use the new login and enter the signup for a source account 14 and the like with the usual accommodation for an email password reminder at block 112.

Once the correct login and password have been set up and successfully entered and confirmed at block 113, the intermediary service 20 confirms at block 120 that the client 12 is not otherwise banned geographically or otherwise from participating. Contact information for the client 12 is obtained at block 121 including minimum identification. At block 122, a first level of personal identification verification establishes if the named client 12 is correctly associated with a corresponding social security number (SSN). This can be confirmed with online services such as Verid or Experian services in the United States. To do so, the client 12 is required to provide some verifiable information such as the last 4 digits of their SSN. If successful, the client 12 is added to the member database and appropriate notices are sent to the client 12.

The client information is stored in a question database at block 123 and, at block 124, secure access identification is provided to the client 12 through the aforementioned email address. The usual welcome information is sent to the client 12 and the client is signed in. The client information may include the details of the source account 14. Source account 14 information can include the account number, institution and routing/transit number.

Deposit Funding Options

With reference to FIG. 2c, at block 130, the client 12 indicates their desire to make a deposit to the online account 21 which can be made available to participating end merchants 11 of the intermediary service 20. In one embodiment, options for deposit comprise the ACH-System 30 dependent approaches, dependent upon a cycle of fund transfer and settlement including credit card, wire transfer and account verification through an interactive verification of activity generated in the identified source account 14. In the case of a credit card and a bank wire or wire transfer, the usual verification can be conducted and payment made to the intermediary services 20 and funds credited to the online account 21. A wire transfer can involve a personal visit to the client's bank; using the bank to authenticate the transfer.

Another deposit approach is to provide a more expeditious approach which is concluded in advance of a full cycle of the ACH-System 30. This approach is more risky for the intermediary service 20.

Turning to the credit card approach, at block 131, the client 12 clicks through a warning page at block 132 and if the client 12 chooses to continue at block 133, the conventional credit card details are entered at block 134 and a credit card authorization and deposit is requested at block 135. If successful at block 136, the deposit is recorded at block 137 and at FIG. 2d, notification is provided by email at block 138 and the funds are available to the online account 21. Typically the funds in the online account 21 or a portion thereof are transferred to the merchant account 13 of the end merchant 11 identified by the client 12 initiating the transfer. Despite a successful credit card authorization and deposit, the intermediary service 20 is still at risk of a charge-back, as discussed above.

Turning again to FIG. 2c, at block 140, a wire transfer approach is less risky due to the need for the client 12 to confirm their identify and confirm the necessary funds in the source account 14 with the financial institution for the source account 14 at the time of transfer. At block 141, FIG. 2d, the wire transfer details are confirmed and an advance is made.

Returning to FIG. 2c, for expedited deposit of requested funds to the online account 21, one can implement an expeditious, and substantially instant and virtual cash transfer beginning at block 150. This stream is referred to as “Instacash”. At block 151, if the initial identify verification or check at block 122 (FIG. 2b) is questionable, wherein the match threshold is doe not reach the verification threshold, then the client 12 is routed to an online check stream in which a full cycle of the ACH-System 30 is required to lessen an otherwise apparently higher than acceptable risk transaction. In other words, the Instacash stream is denied.

If the basic verification is successful, then at block 153 the client is given the choice of an online check at block 152 or continuing on the Instacash stream which is still optional due to possible variation in fees applicable with the different streams. Upon selecting the Instacash stream, an identify verification is conducted at block 154.

Verification

Verification at block 154 may vary by geographical region, but typically comprises the client 12 answering 2-4 questions about themselves. Contrary to the usual case of merely confirming financial data with a credit bureau, the population of qualifying clients 12 is substantially increased through an emphasis on non-financial information. In contradistinction to credit bureau formats, these questions are general in nature rather than financial. The verification process authenticates the client's authorization to transfer funds from the source account 14.

Where available, the legitimacy of the client's request, such as the existence and accessibility of the client's source account 14, is confirmed through ATM Verify. ATM Verify includes status information including open or closed, funds frozen, whether able to receive ACH-System debit, and positive or negative balances. ATM Verify is not available in all areas.

In greater detail, while credit bureau information is readily available, such as from Experian, many potential clients 12 and users of such online financial intermediaries 20 may not have ever owned a house, paid a mortgage, owned a car, made car payments and thus, while capable of making the financial commitment, would not have the financial credit history to enter the system. Thus, a question database is accessible by the server system 20s having two or more authenticating questions, at least one of which is non-financial.

Information validation services such as Verid, Inc. compile and enable verification of identify through non-financial inquiries regarding the client's travels, pin-pointing of street addresses, color of car, and making selections from a list of known, possible and fictitious associates. All of the authentication questions could be non-financial.

Due to possible inaccuracies in data or its currency, it is not expected that a client 12 would necessarily answer all questions to correspond exactly to the answers on file. Thus, there is a usual threshold set such as a majority of the questions, for example 2 out of 3 questions, will qualify as a pass, or alternatively for example, 2 out of 3 questions could trigger a second round of an additional number of questions. Based on the strength of the client's assertion, various options are available including conducting posing further questions and/or re-directing the client to an alternate funding approach.

The server system 20s accesses at least one information server 44d having corresponding account holder specific answers to the authenticating questions. The server system 20s poses the authenticating questions to the client 12 and receives client answers. The client's answers are compared against the account holder specific answers for assessing a match threshold. If the match threshold meets a verification threshold, then the requesting client's authorization to transfer funds from the source account 14 is authenticated.

If the client's identity does not meet the necessary threshold, they can be routed to more secure, albeit more time-consuming methods, such as the online check at block 152.

If the client 12 answers the questions correctly, they qualify for Instacash at block 156. The source account 14 banking information is obtained or confirmed, if already provided. At block 157 an Instacash transfer is approved for deposit to the online account 21. At block 158, a modest, finite and maximum amount (e.g. $750) is immediately credited to their online account 21 for settlement and recordation at block 159 from the source account 14 registered earlier. Confirmations at block 138 and 139 are forwarded to the client 12.

Regardless of the amount of the requested transfer, a permitted amount for transfer to the online account 21 is initially limited and reduces the risk to the financial intermediary service 20 by minimizing the loss amount in the event the client's source account 14 ultimately fails the ACH-System 30 withdrawal transaction.

Once the transfer is made, or an allocation to the credit of the client 12 is made by the intermediary service 20 to the online account 21, the client 12 is permitted to immediately transfer the funds to the participating online end merchant 111 registered with the intermediary service 20. Usual in the full cycle of the ACH-System 30, and provided as part of the preferred methodology, although the funds are available for transfer immediately to the end merchant 11 as transferred funds, the corresponding settlement withdrawal from the source account 14 can take up to 4 days to clear the client's source account 14.

In such cases, the intermediary service 20 obtains a fee, typically as a fixed amount or percentage of the amount of the transferred funds. In one embodiment, as the funds being requested for payment to the online account 21 are for a specific amount to meet a specific payment to an end merchant 11, the intermediary service 20 withdraws the settlement amount including an additional service fee.

The intermediary service 20 commences the more time-consuming ACH-System approach for recovering the finite amount from the source account 14 while the client 12 immediately obtains the use and benefit of the funds in the online account 21 for payment to a specified end merchant 11 or for other uses.

Failing Verification

Alternatively, the client 12 may choose at block 153, or be required at block 155 upon failing to meet a verification threshold, to enter a delayed (several days) account verification process. Similarly, this option is available from block 130 wherein a micro-deposit is made to the source account 14 at block 160. The intermediary service 20 can perform one or more ACH-System transactions at the source account 14 which can be reviewed and confirmed by the client 12. For instance, a small test deposit, the specifics of which can be confirmed by the client, such as by making payment of an identical value to the online account 21. Test deposits arrive in American client's accounts in 1-2 working days and 1-5 working days in Canadian client's accounts. Once the specifics, such as the test deposit amount, has been confirmed then the source account 14 and online account 21 are available for use.

At block 152, and related to the Instacash stream, one might still opt for an alternate form of payment called an online check. This is a service which provides an online form resembling a check and which prompts for details from the client's own checks. In some instances, the information is encrypted, forwarded to a service for processing and ACH-System 30 performs an EFT, typically within 2 days. Alternatively, the financial intermediary 20 provides the online check, collects the information, and performs either a verification micro deposit to the named source account 14 or submits an ACH-System request for deposit.

In review, for immediate payment to an online account 21 for funding of an end merchant 11, the client 12 needs to turn to the Instacash option, wherein few or none of the conventional confirmation and time-consuming safeguards are in place.

The intermediary service 20 recognizes that the client 12 is likely (due to the client's selection of the Instacash approach) to make an immediate withdrawal for payment to a participating end merchant 11. Thus, while the intermediary service 20 does forthwith initiate an ACH-System EFT request to settle their account by withdrawal from the client's source account 14, it will take several days to clear or it may not clear at all due to either lack of funds or perhaps fraud on behalf of a misrepresenting “client”. Thus, several preferred systems are in place to ensure losses are recovered. A fee is charged to each client for each access to such a deposit option for such convenience. The increased risk, in immediate release of funds to a client 12, is balanced against the increased throughput and the fees collected. A percentage of the value of each Instacash withdrawal can be charged for each access. Further, on the financial intermediary's interactive internet site 100, each time a client 12 selects another optional and delayed deposit or funding means, such as a credit card (for which a the card issuer earns a percentage) or a wire transfer (for which the financial institution generally earns a fee), the client 12 is given the option to try Instacash. Further, once Instacash has been used, options can be provided to avoid future fees by implementing alternate access to payment means. Further, a variety of transaction notifications are provided which emphasize the convenience of Instacash and ways to avoid fees in the future, all of which aid the client 12 in convenience and the intermediary in its financial goals.

Raising or increasing the amounts of funding (a higher permitted amount) would typically only follow once the payor client's source account 14 has been verified, either through the longer process or after the client's source account 14 was successfully accessed and the settlement funds withdrawn. For example, after the settlement transaction results in recovery of at least the permitted amount of the requested funds from the source account 14, then one can raises the permitted amount for subsequent transfers of funds.

Various thresholds can be made available to the payor dependent on the status of the client 12 and the client's source account 14. For example, as discussed above: an initial limit for immediate advance may be about $750 as discussed above and based on registration of a bank account and verification of the client's identify through the non-financial questions and answers. For some geographical locations, such as in Canada, in lieu of verification, the client 12 could be prompted to enter the phone number registered in their name.

Additional approaches can be added as alternatives or once confidence in the client 12 is confirmed. For instance, a next financial limit may be increased from a one time advance to a series of advanced, for example, $750 per week. This limit would be based on the more time-consuming interactive verification of the client's access to a specified account, including to verify the client's source account 14 by confirming specific activity in the source account 14 such as a small test deposit amount for less than one dollar which is confirmed by the payor upon inspection. Note that test deposits take 1-2 business days to arrive in bank accounts in the United States and 1-5 business days to arrive in Canadian bank accounts. Once verified, the client 12 is able to pay the intermediary and fund the online account 21 for immediate use.

A next financial limit and subsequent escalating limits might be a set amount and periodic (e.g. $1500 per week) which would become available once the client's source account 14 is verified as above, and once the client 12 has had the equivalent value (e.g. $1500) clear the client's online account and as successfully settled from the client's source account 14.

Merchant Indemnification

In another embodiment of the invention, the risk to the end merchant 11 is reduced or eliminated though a system for merchant indemnification. The intermediary service 20 becomes an intermediate merchant of financial services and becomes an intermediate recipient which would bear the results of a dishonoured EFT or charge back. The intermediary service 20 effectively indemnifies funds transferred to the end merchant 111 and then settles their own online account 21 by an EFT from the client's source account 14. Further examples of systems allocating risk and responses to failed settlements are set forth in co-pending U.S. Regular patent application Ser. No. 10/926,968 filed Aug. 27, 2004 to the inventors.

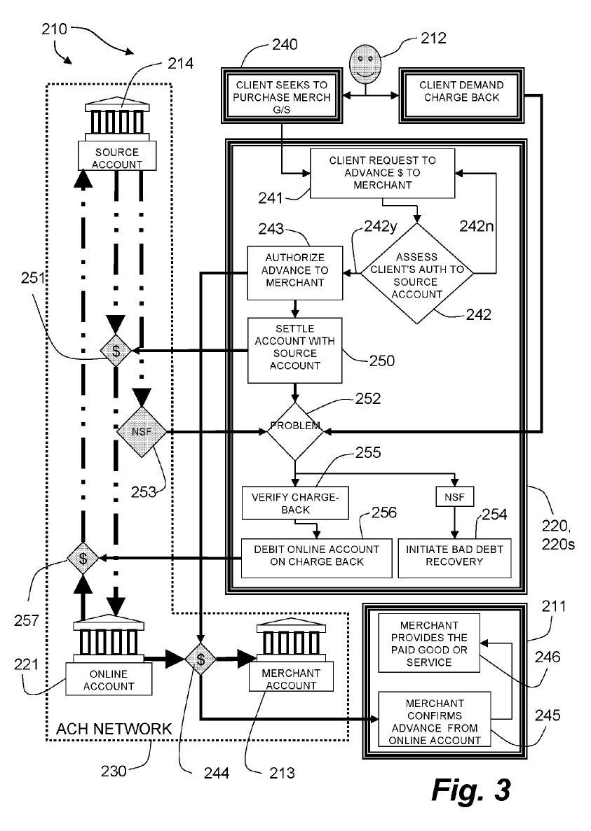

As shown in FIG. 3, the indemnification has many aspects in common with the expedited transfer system of FIG. 1 above. At block 240, there is an arrangement between an end merchant 211 and a client 212 which requires a transfer of funds such as for the purchase of goods or services. The client 212 is referred to an intermediary server 220, by the end merchant 211 or other information source.

The client 212 enters into communication with the intermediary service 220 through server 220s and at block 241 makes a request for the intermediary service 220 to advance the requested funds to the end merchant 211. At block 242, the server 220s interacts with the client 212 to obtain identification of a source account 214 and assess the client's right to dispense the requested funds from the source account 214. This assessment may be the identity verification of the expedited transfer system of FIGS. 1,2a-2d above or some other authorization process. If the assessment is not positive 242n, the server may try again or seek alternate funding options discussed in greater detail as set forth in FIGS. 2a-2d.

If the assessment is positive 242y then, at block 243, an amount of funds is authorized for advance to the end merchant 211. The assessment may result in limiting the amount of the requested funds to a maximum permitted amount. For example, if the assessment is positive yet minimal, having a low threshold, the maximum permitted amount of the funds for transfer may be limited to $750 USD.

The authorization for transfer, at block 243, results in an EFT request 244 to an ACH-System 230 for transfer of the permitted amount of funds from the online account 221 to the merchant's account 213. These transferred funds are irrevocably deposited to the merchant account 213. The end merchant 211 confirms, at block 245, that the transferred funds are received and, at block 246, that the end merchant 211 and client 212 may proceed to conduct their financial transaction.

Only after the transferred funds are irrevocably transferred to the end merchant 211, at block 243, does the intermediary service 220 attempt to settle accounts at block 250 through an EFT request 251 to the ACH-System 230 for transfer of at least the amount of the transferred funds from the source account 214 to the online account 221. A surcharge fee may be added to the transferred amount included in the EFT request 251.

Usually, the EFT request 251 is honored and the online account 221 is properly reimbursed. On the other-hand, problems occur in settlement or recovery of funds from the source account 214.

The transferred funds may become returned funds.

At block 253, the financial institution for the source account 214 may dishonor the request for one of many reasons including incorrect identification of the source account, improper authorization for that client 212 or merely insufficient funds (NSF). Such a problem is detected early on and is hopefully solved through contact with the client 212 for corrected details or more rigorous debt-recovery techniques at block 254. There is not a claw back of the transferred funds from the end merchant 211 and the merchant account 213. The risk is fully that of the intermediary service 220 and not that of the end merchant 211.

Other problems include a charge-back. A charge back may come from a financial institution or credit card issuer such as in the case that the requested funds were through a fraudulent transaction—simply the requesting client 212 was not authorized to disperse funds from the source account 214. It is also known that a client 212, though authorized to draw from the source account 214, may decide to reverse the transaction in breach of their contractual obligations. Financial institutions generally comply with the client's demand.

Accordingly, at block 255, the intermediary service 220 would verify the charge-back details and, at block 256, make a third electronic transfer for the permitted amount of the requested funds back to the source account 214 from whence they were originally drawn by initiating an EFT request, at block 257.

Again, there is no reversal of the transferred funds from the end merchant 211 and the merchant account 213. The risk is fully that of the intermediary service 220 and resolution is between the intermediary service 220 and the requesting client 212, not the end merchant 211.

It is an acknowledged and calculated risk that some transactions initiated by clients 212 will fail or result in a charge-back. The financial intermediary 220 will seek recovery in some other known fashion, some of which are described in greater detail in co-pending application 10/926,968. The intermediary service 220 could seek the assistance of the participating end merchant 211 to provide any information that would aid in recovery of the returned funds. For example, the intermediary service 220 could request the end merchant 211 report any residual amount of the requesting client's transferred funds at the time of the demand; and submitting a fourth electronic fund transfer for the amount of the residual amount from the end merchant's destination client account 213 to the intermediary account 221.

The foregoing invention has been described in terms of the preferred embodiment. However, it will be apparent to those skilled in the art that various modifications and variations can be made in the disclosed process without departing from the scope or spirit of the invention. The specification and examples are exemplary only, while the true scope of the invention is defined by the claims.

What is claimed is:

1. A method for making an expeditious transfer of funds to an end merchant at the request of a client without waiting for settlement of an electronic fund transfer from a source account of the requesting client, the method comprising:
providing an intermediary service having a server system in electronic communication with at least the client, the client's source account, the end merchant, and an intermediate account;
receiving at the intermediary service a request from the requesting client to transfer an amount of requested funds to the end merchant from the client's source account;
obtaining from the requesting client an assertion of the requesting client's authorization to transfer funds from the source account;
authenticating the client's authorization to transfer funds from the source account by establishing a strength of the assertion and at least a permitted amount of the requested funds to be transferred based on the strength of the client's assertion, the authenticating of the client authorization further comprising:
providing a question database accessible by the server system and having two or more authenticating questions, at least one of which is non-financial,
accessing at least one information server by the server system, the at least one information server having corresponding account holder specific answers to the authenticating questions,
posing the authenticating questions to the client and receiving client answers,
comparing the client answers and the account holder specific answers for assessing a match threshold, and
comparing the match threshold and a verification threshold, and if the match threshold meets the verification threshold, then authenticating the requesting client's authorization to transfer funds from the source account; and
substantially contemporaneous with the authentication, initiating a first electronic fund transfer of the least a permitted amount of the requested funds from the intermediate account as transferred funds which are transferred to the end merchant; and thereafter initiating a settlement transaction including submitting a second electronic fund transfer for seeking to recover at least the permitted amount of the requested funds from the source account to the intermediary account.

2. The method of claim 1 wherein all of the two or more authenticating questions are non-financial.

3. The method of claim 1 wherein after the settlement transaction results in recovery of at least the permitted amount of the requested funds from the source account, then further comprising increasing the permitted amount for subsequent transfers of funds to an end merchant at the request of the client.

4. The method of claim 1 wherein the transfers of funds to an end merchant is to an end merchant's account.

5. The method of claim 1 wherein the existence of the client's source account is confirmed through a verification of the existence of the source account through the ACH-System.

6. The method of claim 1 wherein the verification threshold is a majority of the authenticating questions.

7. The method of claim 6 wherein all of the two or more authenticating questions are non-financial.

8. The method of claim 1 wherein the verification threshold is not met, further comprising:
posing an additional set of authenticating questions to the client and receiving additional client answers,
comparing the additional client answers and corresponding account holder specific answers for the additional set of authenticating questions for assessing an additional match threshold; and
comparing the additional match threshold and an additional verification threshold, and the additional verification threshold is met, then authenticating the requesting client's authorization to transfer funds from the source account.

9. The method of claim 1 wherein the obtaining of an assertion of the requested client's authorization to transfer funds from the source account further comprises challenging the requesting client through the two or more authenticating questions by electronic communication.

10. The method of claim 1 further comprising
irrevocably committing the at least permitted amount of the requested amount of the requested funds as the transferred funds to the end merchant.

11. The method of claim 10 wherein upon concluding the settlement transaction and wherein the amount of the transferred funds exceeds the amount ultimately received from the source account, further comprising:
settling accounts, up to the at least a permitted amount of the requested funds, the settled account being only between the source account and the intermediate account, so that the end merchant retains the transferred funds.

12. The method of claim 11 wherein upon settling accounts further comprises receiving notification of insufficient funds for the source account.

13. The method of claim 11 wherein upon settling accounts further comprises receiving a charge-back request for the source account.

14. The method of claim 13 wherein the charge-back request is a result of a fraudulent transaction.

15. The method of claim 10 further comprising releasing the transferred funds to a destination client account of the end merchant from which the requesting client can make periodic access to a whole or a part of the transferred funds expressly for purchasing the goods or services of the end merchant.

16. The method of claim 10 further comprising:
receiving a demand to reverse the transfer of funds which were requested from the source account for return to the source account; and submitting a third electronic fund transfer for least the amount of the requested funds from the intermediary account to the source account and thereby indemnifying the transfer of funds to the end merchant's destination client account.

17. The method of claim 16 wherein before submitting the third electronic fund transfer, further comprising: ascertaining the existence and accessibility of the source account.

18. The method of claim 16 wherein:
requesting the end merchant to report any residual amount of the requesting client's transferred funds at the time of the demand; and
submitting a fourth electronic fund transfer for the amount of the residual amount from the end merchant's destination client account to the intermediary account.

19. A system for making an expeditious transfer of funds to an end merchant at the request of a client without waiting for settlement of an electronic fund transfer a source account of the requesting client, the system comprising:
an intermediary service having a server in electronic communication with the client, the end merchant, and an intermediate account;
a client interface for receiving at the intermediary service an request from the requesting client to transfer an amount of requested funds to the end merchant from a source account;
a verification interface for obtaining from the requesting client an assertion of the requesting client's authorization to transfer funds from the source account, the interface posing two or more authenticating questions to the client, at least one of which is non-financial, and limiting a permitted amount of the requested funds to be transferred based on the strength of the client's assertion;
a first automated clearinghouse request means for committing transfer of the permitted amount of the requested funds from the intermediate account as transferred funds which are transferred to the end merchant, the transferred funds being irrevocable to the end merchant; and
a second automated clearinghouse request means for initiating a settlement transaction including transfer of at least the permitted amount of the requested funds from the source account to the intermediary account.

20. The system of claim 19 wherein the verification interface, further comprises:
a question database accessible by the server and having two or more authenticating questions, at least one of which is non-financial, and at least one information server accessible by the authenticating server and having corresponding and account holder specific answers to the non-financial authenticating questions; and wherein the client interface poses the authenticating questions to the client and assesses a success or match threshold; and the server weights the match threshold and if greater than approval threshold, then authenticating the requesting client's authorization to the source account.
